(19) United States
(12) Patent Application Publication
(10) Pub. No.: US 2026/0313528 A1
(43) Pub. Date: Oct. 8, 2026

(54) METHOD AND APPARATUS FOR UE SUBSCRIBED SLICE INFORMATION EXPOSURE

(71) Applicant: Telefonaktiebolaget LM Ericsson (publ), Stockholm (SE)

(72) Inventor: Fengpei Zhang, Guangzhou, Guangdong (CN)

(21) Appl. No.: 19/481,740

(22) PCT Filed: Apr. 23, 2024
(86) PCT No.: PCT/CN2024/089362

§ 371 Date: Nov. 5, 2025

(30) Foreign Application Priority Data
May 15, 2023 (WO) PCT/CN2023/094185

(51) Int. Cl. H04W 48/18; H04W 8/22; H04W 28/02; H04W 48/16

(52) U.S. Cl. CPC H04W 48/18; H04W 8/22; H04W 28/0268; H04W 48/16

(57) ABSTRACT

Embodiments of the present disclosure provide methods and apparatuses for UE subscribed slice information exposure. A method performed by a network exposure function may comprise receiving a first request for getting subscribed slice information of a terminal device from an application function. The method may further comprise sending a first response comprising the subscribed slice information of the terminal device to the application function.

### CLAIM OF PRIORITY

This application claims the priority of PCT International Application No. PCT/CN2023/094185 with the International Filing Date May 15, 2023, the disclosure of which is incorporated by reference herein in its entirety.

### TECHNICAL FIELD

The non-limiting and exemplary embodiments of the present disclosure generally relate to the technical field of communications, and specifically to method and apparatus for user equipment (UE) subscribed slice information exposure.

### BACKGROUND

This section introduces aspects that may facilitate a better understanding of the disclosure. Accordingly, the statements of this section are to be read in this light and are not to be understood as admissions about what is in the prior art or what is not in the prior art.

In a network such as fifth generation core network (5GC), network capability exposure may be provided. For example, the network capability exposure may comprise exposure of network events externally as well as internally towards network functions (NFs) of core network, exposure of provisioning capability towards external functions; exposure of policy and charging capabilities towards external functions, exposure of core network internal capabilities for analytics, exposure of analytics to external party, retrieval of data from external party by network data analytics function (NWDAF), exposure of number of registered UEs and/or established protocol data unit (PDU) sessions for a network slice that is subject to network slice admission control towards core network NFs or external party, etc.

In a network such as 5GC, a network slice instance may be defined within a public land mobile network (PLMN) or within a stand-alone non-public network (SNPN). The network slice instance may include the core network control plane and user plane network functions.

Network slices may differ for supported features and network functions optimizations, in which case such network slices may have e.g. different single network slice selection assistance information (S-NSSAI) with different slice/service types. The operator can deploy multiple network slices delivering exactly the same features but for different groups of UEs, e.g. as they deliver a different committed service and/or because they are dedicated to a customer, in which case such network slices may have e.g. different S-NSSAIs with the same slice/service type but different slice differentiators.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

An application function (AF) may require the subscribed slice information of a given terminal device for various purposes. For example, the AF may automate the procedures which require slice information e.g. to improve efficiency. The AF may determine the slice based on the quality of service (QoS) requirements of a policy. The AF may route application traffic using a target slice. The AF may perform a routing policy to route local area network (LAN) traffic to wide area network (WAN) using the most appropriate network slice(s) according to the QoS requirements. The AF may establish multiple PDU sessions for multiple slices.

However there is no application programming interface (API) exposed by network exposure function (NEF) for the AF to retrieve the subscribed slice information of a given terminal device.

For example, according to 3GPP TS 29.522 V18.1.0, the disclosure of which is incorporated by reference herein in its entirety, there is no NEF API provides UE subscribed slices information According to n to AFs. Camara alliance (accessed from https://camaraproject.org/), there is no telco API provides UE subscribed slices information to invokers.

To overcome or mitigate at least one of above mentioned problems or other problems, the embodiments of the present disclosure propose a solution for UE subscribed slice information exposure.

In a first aspect of the disclosure, there is provided a method performed by a network exposure function. The method may comprise receiving a first request for getting subscribed slice information of a terminal device from an application function. The method may further comprise sending a first response comprising the subscribed slice information of the terminal device to the application function.

In an embodiment, the first request may comprise at least one of an application function identifier, a terminal device identifier, or terminal device address information.

In an embodiment, the terminal device identifier may comprise a generic public subscription identifier.

In an embodiment, the method may further comprise obtaining a subscription permanent identifier based on the terminal device identifier or the terminal device address information.

In an embodiment, obtaining the subscription permanent identifier based on the terminal device identifier may comprise sending a unified data management discovery request comprising the terminal device identifier to a network repository function, receiving a unified data management discovery response comprising a unified data management discovery result from the network repository function, selecting a unified data management instance based on the unified data management discovery result, sending an identifier translation request comprising the terminal device identifier to the selected unified data management instance, and receiving an identifier translation response comprising the subscription permanent identifier from the selected unified data management instance.

In an embodiment, obtaining the subscription permanent identifier based on the terminal device address information may comprise sending a request comprising the terminal device address information to a binding support function and receiving a response comprising the subscription permanent identifier from the binding support function.

In an embodiment, the method may further comprise sending a request comprising the subscription permanent identifier to a unified data management, receiving a response comprising subscription data of the terminal device from the unified data management, and extracting the subscribed slice information of the terminal device from the subscription data of the terminal device.

In an embodiment, the method may further comprise authenticating the first request. The method may further comprise authorizing the first request.

In an embodiment, the subscribed slice information of the terminal device may comprise at least one of single network slice selection assistance information (S-NSSAI) information, or data network name (DNN) configuration information.

In an embodiment, the S-NSSAI information may comprise at least one of a slice or service type, a slice differentiator or a list of DNNs applicable for a network slice.

In an embodiment, the DNN configuration information may comprise at least one of a data network name, a type of a protocol data unit session, a service and session continuity (SSC) mode, or a subscribed default quality of service (QoS).

In an embodiment, the type of the protocol data unit session may comprise at least one of Internet protocol (IP) version 4, IP version 6, IP version 4 and IP version 6, unstructured, or Ethernet.

In an embodiment, the service and session continuity mode may comprise at least one of SSC mode 1, SSC mode 2 or SSC mode 3.

In an embodiment, the subscribed default QoS may comprise at least one of a fifth generation (5G) QoS identifier, an allocation and retention priority (ARP), a priority level, a minimum guaranteed upstream rate, a maximum best-effort upstream rate, a minimum guaranteed downstream rate, a maximum best-effort downstream rate, a maximum downstream burst rate, a maximum upstream burst rate, priority information, packet delay budget information, jitter information, a packet loss rate, or a packet error rate.

In an embodiment, the subscribed slice information of the terminal device may be used for at least one of determining a slice or a terminal device connection that satisfies a requirement of a service or generating a routing policy for the service.

In an embodiment, the application function may comprise at least one of a router management function or a router.

In an embodiment, the terminal device may comprise a router.

In an embodiment, the subscribed slice information may be able to identify at least one terminal device connection.

In an embodiment, the method may further comprise obtaining QoS information of at least one terminal device connection identified by the subscribed slice information.

In an embodiment, obtaining the QoS information may comprise receiving the QoS information from an operational support system or a network management system.

In an embodiment, the first response may further comprise the QoS information.

In an embodiment, the QoS information may comprise at least one of a minimum guaranteed upstream rate, a maximum best-effort upstream rate, a minimum guaranteed downstream rate, a maximum best-effort downstream rate, a maximum downstream burst rate, a maximum upstream burst rate, priority information, packet delay budget information, jitter information, a packet loss rate, or a packet error rate.

In an embodiment, the QoS information may be used for at least one of determining a terminal device connection that satisfies a requirement of a service or generating a routing policy for the service.

In a second aspect of the disclosure, there is provided a method performed by an application function. The method may comprise sending a first request for getting subscribed slice information of a terminal device to a network exposure function. The method may further comprise receiving a first response comprising the subscribed slice information of the terminal device from the network exposure function.

In an embodiment, the first request may comprise at least one of an application function identifier, a terminal device identifier, or terminal device address information.

In an embodiment, the terminal device identifier may comprise a generic public subscription identifier.

In an embodiment, the subscribed slice information of the terminal device may comprise at least one of single network slice selection assistance information (S-NSSAI) information, or data network name (DNN) configuration information.

In an embodiment, the S-NSSAI information may comprise at least one of a slice or service type, a slice differentiator or a list of DNNs applicable for a network slice.

In an embodiment, the DNN configuration information may comprise at least one of a data network name, a type of a protocol data unit session, a service and session continuity (SSC) mode, or a subscribed default quality of service (QoS).

In an embodiment, the type of the protocol data unit session may comprise at least one of Internet protocol (IP) version 4, IP version 6, IP version 4 and IP version 6, unstructured, or Ethernet.

In an embodiment, the service and session continuity mode may comprise at least one of SSC mode 1, SSC mode 2 or SSC mode 3.

In an embodiment, the subscribed default QoS may comprise at least one of a fifth generation (5G) QoS identifier, an allocation and retention priority (ARP), a priority level, a minimum guaranteed upstream rate, a maximum best-effort upstream rate, a minimum guaranteed downstream rate, a maximum best-effort downstream rate, a maximum downstream burst rate, a maximum upstream burst rate, priority information, packet delay budget information, jitter information, a packet loss rate, or a packet error rate.

In an embodiment, the subscribed slice information of the terminal device may be used for at least one of determining a slice or a terminal device connection that satisfies a requirement of a service or generating a routing policy for the service.

In an embodiment, the application function may comprise at least one of a router management function or a router.

In an embodiment, the terminal device may comprise a router.

In an embodiment, the subscribed slice information may be able to identify at least one terminal device connection.

In an embodiment, the first response may further comprise QoS information of at least one terminal device connection identified by the subscribed slice information.

In an embodiment, the QoS information may comprise at least one of a minimum guaranteed upstream rate, a maximum best-effort upstream rate, a minimum guaranteed downstream rate, a maximum best-effort downstream rate, a maximum downstream burst rate, a maximum upstream burst rate, priority information, packet delay budget information, jitter information, a packet loss rate, or a packet error rate.

In an embodiment, the QoS information may be used for at least one of determining a terminal device connection that satisfies a requirement of a service or generating a routing policy for the service.

In a third aspect of the disclosure, there is provided a network exposure function. The network exposure function may comprise a processor and a memory coupled to the processor. Said memory contains instructions executable by said processor. Said network exposure function is operative to receive a first request for getting subscribed slice information of a terminal device from an application function. Said network exposure function is further operative to send a first response comprising the subscribed slice information of the terminal device to the application function.

In a fourth aspect of the disclosure, there is provided an application function. The application function may comprise a processor and a memory coupled to the processor. Said memory contains instructions executable by said processor. Said application function is operative to send a first request for getting subscribed slice information of a terminal device to a network exposure function. Said application function is further operative to receive a first response comprising the subscribed slice information of the terminal device from the network exposure function.

In a fifth aspect of the disclosure, there is provided a network exposure function. The network exposure function may comprise a first receiving module configured to receive a first request for getting subscribed slice information of a terminal device from an application function. The network exposure function may comprise a first sending module configured to send a first response comprising the subscribed slice information of the terminal device to the application function.

In an embodiment, the network exposure function may further comprise an obtaining module configured to obtain a subscription permanent identifier based on the terminal device identifier or the terminal device address information.

In an embodiment, the network exposure function may further comprise a second sending module configured to send a request comprising the subscription permanent identifier to a unified data management.

In an embodiment, the network exposure function may further comprise a second receiving module configured to receive a response comprising subscription data of the terminal device from the unified data management.

In an embodiment, the network exposure function may further comprise an extracting module configured to extract the subscribed slice information of the terminal device from the subscription data of the terminal device.

In an embodiment, the network exposure function may further comprise an authenticating module configured to authenticate the first request.

In an embodiment, the network exposure function may further comprise an authorizing module configured to authorize the first request.

In an embodiment, the network exposure function may further comprise an obtaining module configured to obtain QoS information of at least one terminal device connection identified by the subscribed slice information.

In a sixth aspect of the disclosure, there is provided an application function. The application function may comprise a sending module configured to send a first request for getting subscribed slice information of a terminal device to a network exposure function. The application function may further comprise a receiving module configured to receive a first response comprising the subscribed slice information of the terminal device from the network exposure function.

In a seventh aspect of the disclosure, there is provided a computer-readable storage medium storing instructions which when executed by at least one processor, cause the at least one processor to perform any of the methods according to the first or second aspects of the disclosure.

In an eighth aspect of the disclosure, there is provided a computer program product, comprising instructions which, when executed on at least one processor, cause the at least one processor to perform any of the methods according to the first or second aspects of the disclosure.

Many advantages may be achieved by applying the proposed solution according to embodiments of the present disclosure. In some embodiments herein, it can enable the AF (such as a router management function or a router) to retrieve subscribed slice information of a given terminal device. In some embodiments herein, it can enable the AF (such as a router management function or a router) to retrieve QoS information of at least one terminal device connection of a given terminal device. In some embodiments herein, the AF can automate/improve the procedure(s) which requires slice information or QoS information of a terminal device connection(s). In some embodiments herein, it can improve efficiency. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1a schematically shows a high level architecture in the fifth generation network according to an embodiment of the present disclosure;

FIG. 1b schematically shows the non-roaming architecture for network exposure function in reference point representation;

FIG. 2a shows an example of 5G network slicing concept according to an embodiment of the present disclosure;

FIG. 2b shows an example of enterprise-grade wireless router according to an; embodiment of the present disclosure;

FIG. 3a shows a flowchart of a method according to an embodiment of the present disclosure;

FIG. 3b shows a flowchart of a method according to another embodiment of the present disclosure;

FIG. 3c shows a flowchart of a method according to another embodiment of the present disclosure;

FIG. 3d shows a flowchart of a method according to another embodiment of the present disclosure;

FIG. 3e shows a flowchart of a method according to another embodiment of the present disclosure;

FIG. 3f shows a flowchart of a method according to another embodiment of the present disclosure;

FIG. 3g shows a flowchart of a method according to another embodiment of the present disclosure;

FIG. 4 shows a flowchart of a method according to another embodiment of the present disclosure;

FIG. 5 shows a flowchart of a procedure of GET subscribed slices API according to an embodiment of the present disclosure;

FIG. 6a shows a flowchart of a procedure of router management according to an embodiment of the present disclosure;

FIG. 6b shows a flowchart of a procedure of GET device connections API according to an embodiment of the present disclosure;

FIG. 6c shows a flowchart of a procedure of router management according to another embodiment of the present disclosure;

FIG. 7 is a block diagram showing an apparatus suitable for practicing some embodiments of the disclosure;

FIG. 8a is a block diagram showing a network exposure function according to an embodiment of the disclosure;

FIG. 8b is a block diagram showing an application function according to an embodiment of the disclosure;

FIG. 9 shows an example of a communication system according to an embodiment of the disclosure;

FIG. 10 shows a UE in accordance with some embodiments;

FIG. 11 shows a network node in accordance with some embodiments;

FIG. 12 is a block diagram of a host according to an embodiment of the disclosure;

FIG. 13 is a block diagram illustrating a virtualization environment in which functions implemented by some embodiments may be virtualized; and

FIG. 14 shows a communication diagram of a host communicating via a network node with a UE over a partially wireless connection according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G, 6G communication protocols, and/or any other protocols either currently known or to be developed in the future.

The term “network device” or “network node” or “network function” refers to any suitable function which can be implemented in a network entity (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and Mobility Management Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as Long Term Evolution (LTE)) may include MME (Mobile Management Entity), HSS (home subscriber server), Policy and Charging Rules Function (PCRF), Packet Data Network (PDN) Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3rd Generation Partnership Project (3GPP), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

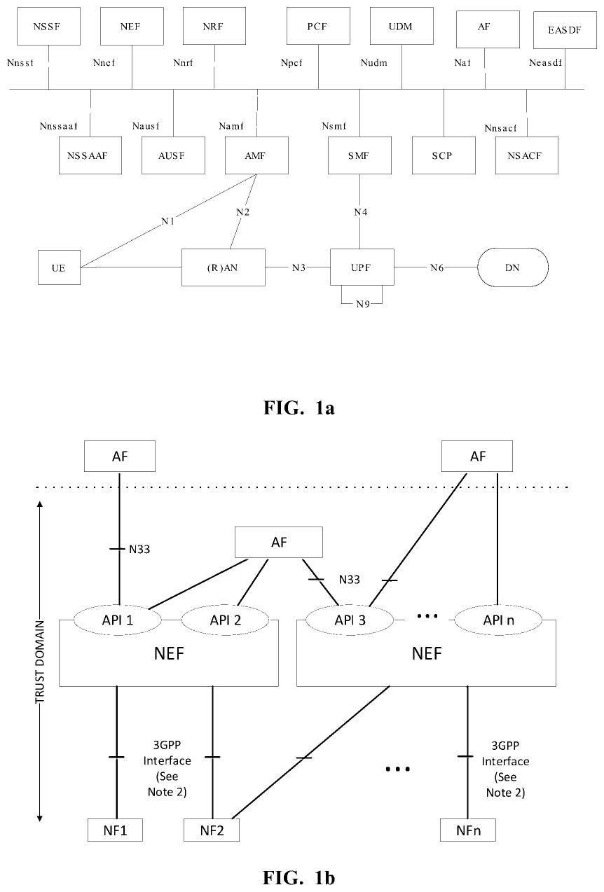

Although the subject matter described herein may be implemented in any appropriate type of system using any suitable components, the embodiments disclosed herein are described in relation to a communication system complied with the exemplary system architecture illustrated in FIG. 1a-1b. For simplicity, the system architectures of FIG. 1a-1b only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

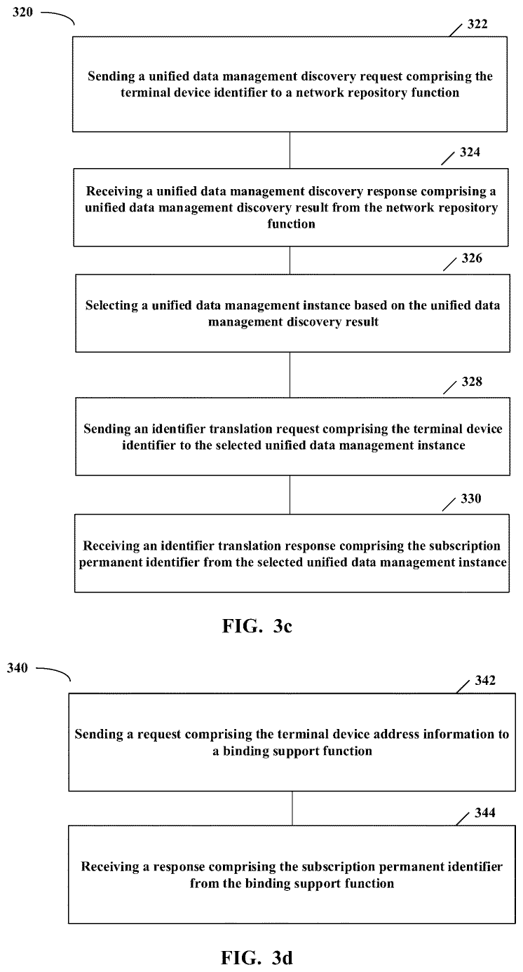

FIG. 1a schematically shows a high level architecture in the fifth generation network according to an embodiment of the present disclosure. The architecture of FIG. 1a is same as FIG. 4.2.3-1 of 3GPP TS 23.501 V18.0.0, the disclosure of which is incorporated by reference herein in its entirety. The system architecture of FIG. 1a may comprise some exemplary elements such as AUSF, AMF, data network (DN), NEF, NRF, NSSF, PCF, SMF, UDM, UPF, AF, UE, (R)AN, Service Communication Proxy (SCP), Network Slice-Specific Authentication and Authorization Function (NSSAAF), Network Slice Admission Control Function (NSACF), Edge Application Server Discovery Function (EASDF), etc.

In accordance with an exemplary embodiment, the UE can establish a signaling connection with the AMF over the reference point N1, as illustrated in FIG. 1a. This signaling connection may enable NAS (Non-access stratum) signaling exchange between the UE and the core network, comprising a signaling connection between the UE and the (R)AN and the N2 connection for this UE between the (R)AN and the AMF. The (R)AN can communicate with the UPF over the reference point N3. The UE can establish a protocol data unit (PDU) session to the DN (data network, e.g. an operator network or Internet) through the UPF over the reference point N6.

As further illustrated in FIG. 1a, the exemplary system architecture also contains the service-based interfaces such as Nnrf, Nnef, Nausf, Nudm, Npcf, Namf, Nnsacf, Neasdf and Nsmf exhibited by NFs such as the NRF, the NEF, the AUSF, the UDM, the PCF, the AMF, the NSACF, the EASDF and the SMF. In addition, FIG. 1a also shows some reference points such as N1, N2, N3, N4, N6 and N9, which can support the interactions between NF services in the NFs. For example, these reference points may be realized through corresponding NF service-based interfaces and by specifying some NF service consumers and providers as well as their interactions in order to perform a particular system procedure.

FIG. 1b schematically shows the non-roaming architecture for network exposure function in reference point representation. The architecture of FIG. 1b is same as FIG. 4.2.3-5 of 3GPP TS 23.501 V18.0.0.

NOTE 1: Trust domain for NEF may be same as trust domain for service capability exposure function (SCEF) as defined in 3GPP TS 23.682 V17.3.0, the disclosure of which is incorporated by reference herein in its entirety. The trust domain may cover entities that are protected by adequate network domain security. The entities and interfaces within the trust domain may all be within one operator's control, or some may be controlled by a trusted business partner which has a trust relationship with the operator e.g. another operator or a third party. N33 is the reference point between NEF and AF. AF may be located in the trust domain or in the untrusted domain.

NOTE 2: 3GPP interface represents southbound interfaces between NEF and 5GC Network Functions e.g. N29 interface between NEF and SMF, N30 interface between NEF and PCF, etc. All southbound interfaces from NEF are not shown for the sake of simplicity.

5G networks, in combination with network slicing, may permit business customers to enjoy connectivity and data processing tailored to the specific business requirements that adhere to a Service Level Agreement (SLA) agreed with the mobile operator. The customizable network capabilities may include data speed, quality of service, network latency, reliability, security, and services.

Slice types may be defined from a functional or behavioral perspective. It is therefore anticipated that mobile network operators may deploy a single network slice type that satisfies the needs of multiple vertical applications, as well as multiple network slices of different types that are packaged as a single product targeted towards business customers (a business bundle) who have multiple and diverse requirements (for example a vehicle may need simultaneously a high bandwidth slice for infotainment and an ultra-reliable slice for telemetry, assisted driving).

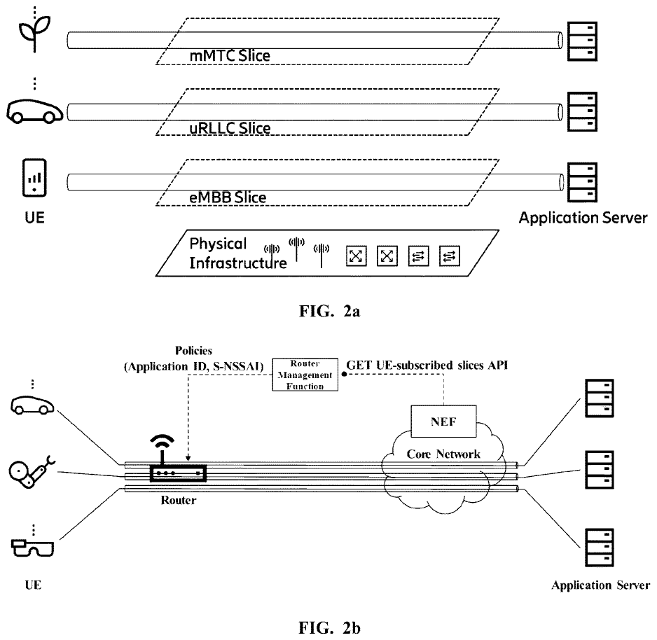

FIG. 2a shows an example of 5G network slicing concept according to an embodiment of the present disclosure.

A network slice may be an independent end-to-end logical network that runs on a shared physical infrastructure. The network slice may be capable of providing a negotiated service quality. Different network slices may deliver different committed services and/or customizable network capabilities to a customer such as UEs and/or application servers.

Though only three slices, such as Enhanced machine type communication (eMTC) slice, Ultra-reliable low latency communications (URLLC) slice, enhanced mobile broadband (eMBB) slice, are shown in FIG. 2a, there may be more or less slices in other embodiments, such as massive Internet of Things (IoT) slice, vehicle-to-everything slice, high-performance machine-type communications slice, etc.

eMTC slice may be an independent end-to-end logical network that runs on a shared physical infrastructure used for eMTC. eMTC is a low power wide area technology which supports IoT through lower device complexity and provides an extended coverage.

URLLC slice may be an independent end-to-end logical network that runs on a shared physical infrastructure used for URLLC. URLLC may support use cases that require high network reliability, e.g. more than 99.999%, and extremely low latency for data transmission, e.g. approximately 1 millisecond. For example, autonomous driving would require a connection capable of this, as there is such high risk involved.

eMBB slice may be an independent end-to-end logical network that runs on a shared physical infrastructure used for eMBB. eMBB may provide greater data-bandwidth complemented by moderate latency improvements on a network. eMBB may help to develop mobile broadband use cases such as emerging Augmented Reality (AR) or Virtual Reality (VR) media and applications, Ultra High Definition or 360-degree streaming video, etc.

Currently, there is no API exposed by NEF for an AF to retrieve the subscribed slice(s) of a given terminal device.

There are use cases requiring this API from a (e.g. 5G) core network. For example, the AF may retrieve the subscribed slices of a given terminal device in the following use cases. The AF may automate the procedures which require slice information to improve efficiency. The AF may determine the slice based on the QoS requirements of a policy. The AF may route corresponding application traffic using a target slice. The AF may perform a routing policy to route LAN traffic to WAN using the most appropriate network slices according to the QoS requirements. The AF may establish multiple PDU sessions for multiple slices.

One of use cases may be enterprise-grade (e.g. 5G) wireless routers with network slicing, which may route LAN traffic to WAN. A router may equip with multiple (e.g. 5G) modems (UEs) with different carrier subscriber identity module (SIM) cards for redundancy and/or capacity purpose. With network slicing, the router may perform routing policies to route LAN traffic to WAN using the most appropriate network slices according to the QoS requirements.

FIG. 2b shows an example of enterprise-grade (e.g. 5G) wireless router according to an embodiment of the present disclosure.

The router may serve different UEs such as vehicles, robots, etc. Each type of UE may have different service requirements. The router management function may manage a large number of routers with multiple modems and SIMs.

One of the challenges of this kind of solution is that the router management function (managing a large number of routers with multiple modems and SIMs) needs to create a policy based on UE-subscribed slice information (application identifier (ID), S-NSSAI). For example, a policy may indicate that the traffic of an application (Application ID and Application Descriptor) will be carried by a network slice (e.g. S-NSSAI) in order to fulfil the required QoS of the application. Without such a network API, the routing policy may need to be created manually. Considering the large number of managed routes (UEs), the efficiency is very low.

To overcome or mitigate at least one of above mentioned problems or other problems, the embodiments of the present disclosure propose a solution for UE subscribed slice information exposure.

In an embodiment, it may introduce a new network capability and API exposed by NEF for an AF to retrieve the subscribed slice(s) of a given terminal device.

In an embodiment, NEF may communicate with UDM to retrieve the slice information exposed by this API.

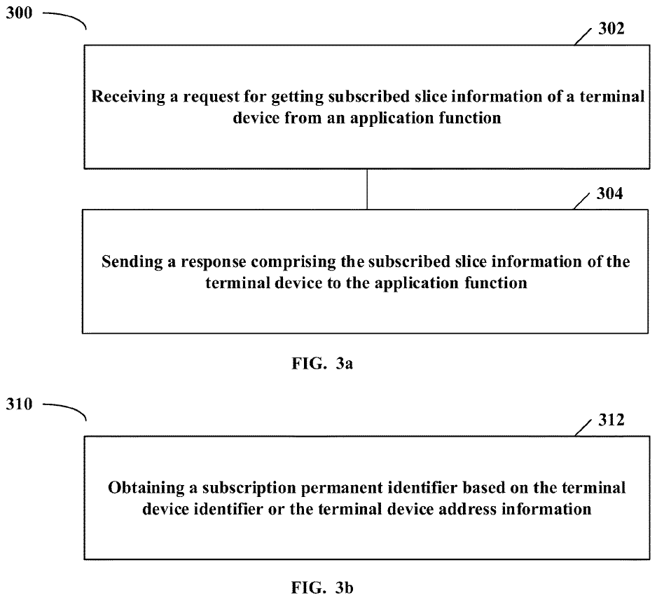

FIG. 3a shows a flowchart of a method according to an embodiment of the present disclosure, which may be performed by an apparatus implemented in/as or communicatively coupled to a network exposure function. As such, the apparatus may provide means for accomplishing various parts of the method 300 as well as means for accomplishing other processes in conjunction with other components.

At block 302, the network exposure function may receive a first request for getting subscribed slice information of a terminal device from an application function.

The network exposure function may be any suitable node or entity or function which can provide network exposure function or service capability exposure function. In an embodiment, the network exposure function may be NEF as described in 3GPP TS 23.501 V18.0.0. In another embodiment, the network exposure function may be SCEF as described in 3GPP TS 23.682 V17.3.0.

In an embodiment, the application function may be any suitable node or entity or function which can provide application function. In an embodiment, the application function may be AF as described in 3GPP TS 23.501 V18.0.0. In another embodiment, the application function may be service capability server (SCS)/application server (AS) as described in 3GPP TS 23.682 V17.3.0.

In an embodiment, the application function may comprise at least one of a router management function or a router.

In an embodiment, the terminal device may comprise a router.

The router management function may manage at least one router. The router may have at least one modem and at least one SIM. The router management function may need to create a policy based on UE-subscribed slice information (e.g. Application ID, S-NSSAI, etc.). A policy may indicate that the traffic of an application (e.g. Application ID and Application Descriptor) will be carried by a network slice (e.g. S-NSSAI) in order to fulfil the required QoS of the application.

The first request may be any suitable request. In an embodiment, the first request may be a UE subscribed slice information get such request, as Nnef_UE-subscribed-slice-information_Get request. For example, the Nnef_UE-subscribed-slice-information_Get request may be a Hyper Text Transfer Protocol (HTTP) GET request.

The first request may comprise any suitable information. For example, the first request may comprise information which can be used to determine or retrieve a subscription permanent identifier of the terminal device.

In an embodiment, the first request may comprise at least one of an application function identifier, a terminal device identifier, or terminal device address information.

The application function identifier may be an identifier of an AF instance. In an embodiment, the application function identifier may be same as the AF ID as described in various 3GPP specifications such as 3GPP TS 23.501 V18.0.0, 3GPP TS 23.502 V18.0.0, etc.

The terminal device identifier may be an identifier of the terminal device. The terminal device identifier may be any suitable identifier. In an embodiment, the terminal device identifier may comprise a generic public subscription identifier. In an embodiment, the generic public subscription identifier may be same as the generic public subscription identifier (GPSI) as described in various 3GPP specifications such as 3GPP TS 23.501 V18.0.0, 3GPP TS 23.502 V18.0.0, etc. The GPSI may be used for addressing a 3GPP subscription in different data networks outside of the 3GPP system. The 3GPP system stores within the subscription data the association between the GPSI and the corresponding subscription permanent identifier (SUPI). GPSIs may be public identifiers used both inside and outside of the 3GPP system. The GPSI may be either a mobile subscriber integrated services digital network (ISDN) number (MSISDN) or an external identifier.

At block 304, the network exposure function may send a first response comprising the subscribed slice information of the terminal device to the application function.

The first response may be any suitable response. In an embodiment, the first response a slice information get response, such as may be UE subscribed Nnef_UE-subscribed-slice-information_Get response. For example, the Nnef_UE-subscribed-slice-information_Get response may be an HTTP GET response.

The network exposure function may obtain the subscribed slice information of the terminal device in various ways and the present disclosure has no limit on it. For example, when the network exposure function has stored or cached the subscribed slice information of the terminal device, the network exposure function may obtain the subscribed slice information of the terminal device by itself. The network exposure function may obtain the subscribed slice information of the terminal device from another network node (such as UDM) which has stored or can retrieve the subscribed slice information of the terminal device. The network exposure function may obtain the subscribed slice information of the terminal device from a SCP which for example may obtain such information from UDM.

The subscribed slice information of the terminal device may comprise any suitable information related to the subscribed slice of the terminal device.

In an embodiment, the subscribed slice information of the terminal device may comprise at least one of single network slice selection assistance information (S-NSSAI) information, or data network name (DNN) configuration information.

The S-NSSAI information may comprise subscribed S-NSSAI which a UE is subscribed to use in a PLMN. In an embodiment, the S-NSSAI may be same or similar as/to the S-NSSAI as described in various 3GPP specifications such as 3GPP TS 23.501 V18.0.0, 3GPP TS 23.502 V18.0.0, etc.

In an embodiment, the S-NSSAI information may comprise at least one of a slice or service type, a slice differentiator, or a list of DNNs applicable for a network slice.

The slice or service type may refer to the expected network slice behavior in terms of features and services. The slice differentiator may be optional information that complements the slice/service type(s) to differentiate amongst multiple network slices of the same slice/service type.

The DNN configuration information may comprise any suitable information related to the configuration of the DNN. In an embodiment, the DNN configuration information may comprise at least one of a data network name, a type of a protocol data unit session, a service and session continuity (SSC) mode, or a subscribed default quality of service (QoS).

The DNN may be a reference to a data network. The DNN may be equivalent to an access point name (APN) as defined in 3GPP TS 23.003 V18.0.0, the disclosure of which is incorporated by reference herein in its entirety. Both identifiers may have an equivalent meaning and carry the same information.

The type of the protocol data unit session may comprise any suitable type of the protocol data unit session. In an embodiment, the type of the protocol data unit session may comprise at least one of Internet protocol (IP) version 4 (IPv4), IP version 6 (IPv6), IP version 4 and IP version 6, unstructured, or Ethernet. The IP version 4, IP version 6, IP version 4 and IP version 6, unstructured, or Ethernet protocol data unit session type may be same or similar as/to the corresponding protocol data unit session type as described in various 3GPP specifications such as 3GPP TS 23.501 V18.0.0, 3GPP TS 23.502 V18.0.0, etc.

The support for session and service continuity in network may enable to address the various continuity requirements of different applications/services for the UE. The network such as 5G system may support different SSC modes. The SSC mode associated with a PDU session may not change during the lifetime of a PDU Session.

In an embodiment, the service and session continuity mode may comprise at least one of SSC mode 1, SSC mode 2, or SSC mode 3.

With SSC mode 1, the network preserves the connectivity service provided to the UE. For the case of PDU Session of IPv4 or IPv6 or IPv4v6 type, the IP address is preserved.

With SSC mode 2, the network may release the connectivity service delivered to the UE and release the corresponding PDU Session(s). For the case of IPv4 or IPv6 or IPv4v6 type, the release of the PDU Session induces the release of IP address(es) that had been allocated to the UE.

With SSC mode 3, changes to the user plane can be visible to the UE, while the network ensures that the UE suffers no loss of connectivity. A connection through new PDU Session Anchor point is established before the previous connection is terminated in order to allow for better service continuity. For the case of IPv4 or IPv6 or IPv4v6 type, the IP address is not preserved in this mode when the PDU session anchor changes.

The subscribed default QoS may comprise any suitable information related to QoS. In an embodiment, the subscribed default QoS may comprise at least one of a fifth generation (5G) QoS identifier, an allocation and retention priority (ARP), or a priority level.

In an embodiment, the subscribed default QoS may comprise at least one of a minimum guaranteed upstream rate, a maximum best-effort upstream rate, a minimum guaranteed downstream rate, a maximum best-effort downstream rate, a maximum downstream burst rate, a maximum upstream burst rate, priority information, packet delay budget information, jitter information, a packet loss rate, or a packet error rate.

For example, the minimum guaranteed upstream rate may indicate minimum upstream rate ensured by Guaranteed Bit Rate (GBR) QoS Class Identifier (QCI). The minimum guaranteed downstream rate may indicate minimum downstream rate ensured by GBR QCI. The maximum upstream burst rate may enable the network to burst data at a higher rate than the maximum best-effort upstream rate for a period of time. The maximum downstream best effort data rate may enable the network to burst data at a higher rate than the maximum best-effort downstream rate for a period of time. The priority information may indicate priority level(s) which may allow efficient resource allocation and ensure optimal performance for various services. The packet delay budget information may indicate the packet delay budget which may be the maximum allowable one-way latency between the terminal device and the gateway from the operator's network to other networks. The jitter information may indicate the jitter requirement which may aim to limit the maximum variation in round-trip packet delay for the 99th percentile of traffic, following International Telecommunication Union (ITU) Y.1540 standards. The packet loss rate and/or the packet error rate may indicate exponential power of the allowable error loss rate 10^{(-N)}. N may be any suitable value.

The 5G QoS identifier (5Q1) may be an identifier for the authorized QoS parameters for the service data flow. The ARP for the service data flow may comprise at least one of the priority level, the pre-emption capability and the pre-emption vulnerability. The priority level may indicate a priority in scheduling resources among QoS Flows.

In an embodiment, the 5G QoS identifier, the ARP and the priority level may be same or similar as/to the corresponding terms as described in various 3GPP specifications such as 3GPP TS 23.501 V18.0.0, 3GPP TS 23.502 V18.0.0, etc.

The subscribed slice information of the terminal device may be used for various purposes for example depending on specific use cases. For example, the AF may automate the procedures which require slice information to improve efficiency. The AF may determine the slice based on the QoS requirements of a policy. The AF may route corresponding application traffic using a target slice. The AF may perform a routing policy to route LAN traffic to WAN using the most appropriate network slices according to the QoS requirements. The AF may establish multiple PDU sessions for multiple slices.

In an embodiment, the subscribed slice information of the terminal device may be used for at least one of determining a slice that satisfies a requirement of a service or generating a routing policy for the service.

In an embodiment, the subscribed slice information of the terminal device may be used for at least one of determining a terminal device connection that satisfies a requirement of a service or generating a routing policy for the service.

In an embodiment, the subscribed slice information may be able to identify at least one terminal device connection. For example, a terminal device connection (such as PDU session) may be identified by SUPI, DNN and S-NSSAI.

FIG. 3b shows a flowchart of a method according to another embodiment of the present disclosure, which may be performed by an apparatus implemented in/as or communicatively coupled to a network exposure function. As such, the apparatus may provide means for accomplishing various parts of the method 310 as well as means for accomplishing other processes in conjunction with other components. For some parts which have been described in the above embodiments, the description thereof is omitted here for brevity.

At block 312, the network exposure function may obtain a subscription permanent identifier based on the terminal device identifier or the terminal device address information.

The subscription permanent identifier may be a globally unique SUPI which may be allocated to each subscriber in the network such as 5G system and provisioned in a storage function such as UDM/Unified Data Repository (UDR). The SUPI may be used only inside the network such as 3GPP system. In an embodiment, the subscription permanent identifier may be same or similar as/to the SUPI as described in various 3GPP specifications such as 3GPP TS 23.501 V18.0.0, 3GPP TS 23.502 V18.0.0, etc.

The terminal device address information may comprise any suitable address information. For example, the terminal device address information may comprise UE IP address or medium access control (MAC) address.

The network exposure function may obtain the subscription permanent identifier based on the terminal device identifier or the terminal device address information in various ways and the present disclosure has no limit on it. For example, when a network function stores a mapping between the subscription permanent identifier and the terminal device identifier or the terminal device address information, the network exposure function may send the terminal device identifier or the terminal device address information to the network function and receive the subscription permanent identifier from the network function.

FIG. 3c shows a flowchart of a method according to another embodiment of the present disclosure, which may be performed by an apparatus implemented in/as or communicatively coupled to a network exposure function. As such, the apparatus may provide means for accomplishing various parts of the method 320 as well as means for accomplishing other processes in conjunction with other components. For some parts which have been described in the above embodiments, the description thereof is omitted here for brevity.

At block 322, the network exposure function may send a unified data management discovery request comprising the terminal device identifier to a network repository function.

The network repository function may be any suitable NF which can support service discovery function. The network repository function may receive an NF discovery request from the network exposure function, and provide the information of the discovered NF instances (be discovered) to the network exposure function. In an embodiment, the network repository function may be same or similar as/to the NRF as described in various 3GPP specifications such as 3GPP TS 23.501 V18.0.0, 3GPP TS 23.502 V18.0.0, etc.

At block 324, the network exposure function may receive a unified data management discovery response comprising a unified data management discovery result from the network repository function.

At block 326, the network exposure function may select a unified data management instance based on the unified data management discovery result.

The unified data management may be any suitable NF which can support subscription management. The unified data management may receive an identifier translation request comprising the terminal device identifier from the network exposure function, and provide an identifier translation result comprising the subscription permanent identifier to the network exposure function. In an embodiment, the unified data management may be same or similar as/to the UDM as described in various 3GPP specifications such as 3GPP TS 23.501 V18.0.0, 3GPP TS 23.502 V18.0.0, etc.

At block 328, the network exposure function may send an identifier translation request comprising the terminal device identifier to the selected unified data management instance.

At block 330, the network exposure function may receive an identifier translation response comprising the subscription permanent identifier from the selected unified data management instance.

FIG. 3d shows a flowchart of a method according to another embodiment of the present disclosure, which may be performed by an apparatus implemented in/as or communicatively coupled to a network exposure function. As such, the apparatus may provide means for accomplishing various parts of the method 340 as well as means for accomplishing other processes in conjunction with other components. For some parts which have been described in the above embodiments, the description thereof is omitted here for brevity.

At block 342, the network exposure function may send a request comprising the terminal device address information to a binding support function.

The binding support function may be any suitable NF which can support binding support function. The binding support function may receive a request comprising the terminal device address information from the network exposure function, and provide a response comprising the subscription permanent identifier to the network exposure function. In an embodiment, the binding support function may be same or similar as/to the binding support function as described in various 3GPP specifications such as 3GPP TS 23.501 V18.0.0, 3GPP TS 23.502 V18.0.0, 3GPP TS 23.503 V18.1.0, etc.

At block 344, the network exposure function may receive a response comprising the subscription permanent identifier from the binding support function.

For example, according to 3GPP TS 23.502 V18.0.0, the NEF may use the Nbsf_Management_Discovery service operation with UE address and IP domain and/or DNN and/or S-NSSAI to retrieve the session binding information (comprising the subscription permanent identifier) of the UE.

FIG. 3e shows a flowchart of a method according to another embodiment of the present disclosure, which may be performed by an apparatus implemented in/as or communicatively coupled to a network exposure function. As such, the apparatus may provide means for accomplishing various parts of the method 350 as well as means for accomplishing other processes in conjunction with other components. For some parts which have been described in the above embodiments, the description thereof is omitted here for brevity.

At block 352, the network exposure function may send a request comprising the subscription permanent identifier to a unified data management.

The request may comprise information indicating to obtaining the subscription data of the terminal device or the subscribed slice information of the terminal device.

At block 354, the network exposure function may receive a response comprising subscription data of the terminal device from the unified data management.

In an embodiment, the subscription data of the terminal device may be the session management subscription data of the terminal device.

In an embodiment, the subscription data of the terminal device may be the subscribed slice information of the terminal device. In this case block 356 can be skipped.

At block 356, the network exposure function may extract the subscribed slice information of the terminal device from the subscription data of the terminal device.

FIG. 3f shows a flowchart of a method according to another embodiment of the present disclosure, which may be performed by an apparatus implemented in/as or communicatively coupled to a network exposure function. As such, the apparatus may provide means for accomplishing various parts of the method 360 as well as means for accomplishing other processes in conjunction with other components. For some parts which have been described in the above embodiments, the description thereof is omitted here for brevity.

At block 362, the network exposure function may authenticate the first request.

The NEF may authenticate the first request. If the authentication is failed, the NEF replies to the AF with a result value indicating authentication failure. Otherwise the NEF proceeds with the following steps.

At block 364, the network exposure function may authorize the first request.

The NEF may authorize the first request. If the authorization is not granted, the NEF replies to the AF with a result value indicating authorization failure. Otherwise the NEF proceeds with the following steps.

FIG. 3g shows a flowchart of a method according to another embodiment of the present disclosure, which may be performed by an apparatus implemented in/as or communicatively coupled to a network exposure function. As such, the apparatus may provide means for accomplishing various parts of the method 370 as well as means for accomplishing other processes in conjunction with other components. For some parts which have been described in the above embodiments, the description thereof is omitted here for brevity.

At block 372, the network exposure function may obtain QoS information of at least one terminal device connection identified by the subscribed slice information.

The network exposure function may obtain the QoS information in various ways and the present disclosure has no limit on it.

In an embodiment, the network exposure function may receive the QoS information from an operational support system or a network management system. For example, the operational support system may provision the QoS information to the network exposure function such as NEF. The QoS information may indicate the default QoS characteristics of at least one device connection.

In an embodiment, the network exposure function may receive the QoS information from any other suitable network node such as UDM. For example, the subscribed slice information of the terminal device may comprise the QoS information and the network exposure function may extract the QoS information from the subscribed slice information of the terminal device.

In an embodiment, the first response may further comprise the QoS information.

The QoS information may comprise any suitable QoS information related to the at least one terminal device connection. In an embodiment, the QoS information may comprise at least one of a minimum guaranteed upstream rate, a maximum best-effort upstream rate, a minimum guaranteed downstream rate, a maximum best-effort downstream rate, a maximum downstream burst rate, a maximum upstream burst rate, priority information, jitter information, packet delay budget information, a packet loss rate, or a packet error rate.

The QoS information may be used for various purposes for example depending on specific use cases. For example, the AF may automate the procedures which require the QoS information to improve efficiency. The AF may determine the terminal device connection based on the QoS requirements of a policy. The AF may route corresponding application traffic using a target terminal device connection. The AF may perform a routing policy to route LAN traffic to WAN using the most appropriate terminal device connection according to the QoS requirements. The AF may establish multiple terminal device connections for multiple slices.

In an embodiment, the QoS information may be used for at least one of determining a terminal device connection that satisfies a requirement of a service or generating a routing policy for the service.

FIG. 4 shows a flowchart of a method according to another embodiment of the present disclosure, which may be performed by an apparatus implemented in/as or communicatively coupled to an application function. As such, the apparatus may provide means for accomplishing various parts of the method 400 as well as means for accomplishing other processes in conjunction with other components. For some parts which have been described in the above embodiments, the description thereof is omitted here for brevity.

At block 402, the application function may send a first request for getting subscribed slice information of a terminal device to a network exposure function.

At block 404, the application function may receive a first response comprising the subscribed slice information of the terminal device from the network exposure function.

The application function may use the subscribed slice information of the terminal device in a procedure which requires slice information. The procedure may be any suitable procedure and the present disclosure has no limit on it. For example, the application function may use the subscribed slice information of the terminal device in a procedure which requires slice information to improve efficiency.

In an embodiment, the subscribed slice information of the terminal device may be used for at least one of determining a slice or a terminal device connection that satisfies a requirement of a service or generating a routing policy for the service.

In an embodiment, the first request may comprise at least one of an application function identifier, a terminal device identifier, or terminal device address information.

In an embodiment, the terminal device identifier may comprise a generic public subscription identifier.

In an embodiment, the subscribed slice information of the terminal device may comprise at least one of single network slice selection assistance information (S-NSSAI) information, or data network name (DNN) configuration information.

In an embodiment, the S-NSSAI information may comprise at least one of a slice or service type, a slice differentiator, or a list of DNNs applicable for a network slice.

In an embodiment, the DNN configuration information may comprise at least one of a data network name, a type of a protocol data unit session, a service and session continuity (SSC) mode, or a subscribed default quality of service (QoS).

In an embodiment, the type of the protocol data unit session may comprise at least one of Internet protocol (IP) version 4, IP version 6, IP version 4 and IP version 6, unstructured, or Ethernet.

In an embodiment, the service and session continuity mode may comprise at least one of SSC mode 1, SSC mode 2, or SSC mode 3.

In an embodiment, the subscribed default QoS may comprise at least one of a fifth generation (5G) QoS identifier, an allocation and retention priority (ARP), or a priority level.

In an embodiment, the subscribed default QoS may comprise at least one of a minimum guaranteed upstream rate, a maximum best-effort upstream rate, a minimum guaranteed downstream rate, a maximum best-effort downstream rate, a maximum downstream burst rate, a maximum upstream burst rate, priority information, packet delay budget information, jitter information, a packet loss rate, or a packet error rate.

In an embodiment, the application function comprises at least one of a router management function, or a router.

In an embodiment, the terminal device may comprise a router.

In an embodiment, the subscribed slice information may be able to identify at least one terminal device connection.

In an embodiment, the first response may further comprise QoS information of at least one terminal device connection identified by the subscribed slice information.

In an embodiment, the QoS information may comprise at least one of a minimum guaranteed upstream rate, a maximum best-effort upstream rate, a minimum guaranteed downstream rate, a maximum best-effort downstream rate, a maximum downstream burst rate, a maximum upstream burst rate, priority information, jitter information, packet delay budget information, a packet loss rate, or a packet error rate.

In an embodiment, the QoS information may be used for at least one of determining a terminal device connection that satisfies a requirement of a service or generating a routing policy for the service.

In an embodiment, it may follow the architecture illustrated by FIG. 1b. The NEF may expose network capabilities toward both trusted and untrusted AFs. The NEF may interact with other NF (e.g., SMF, PCF, UDM, etc.) to support network exposure.

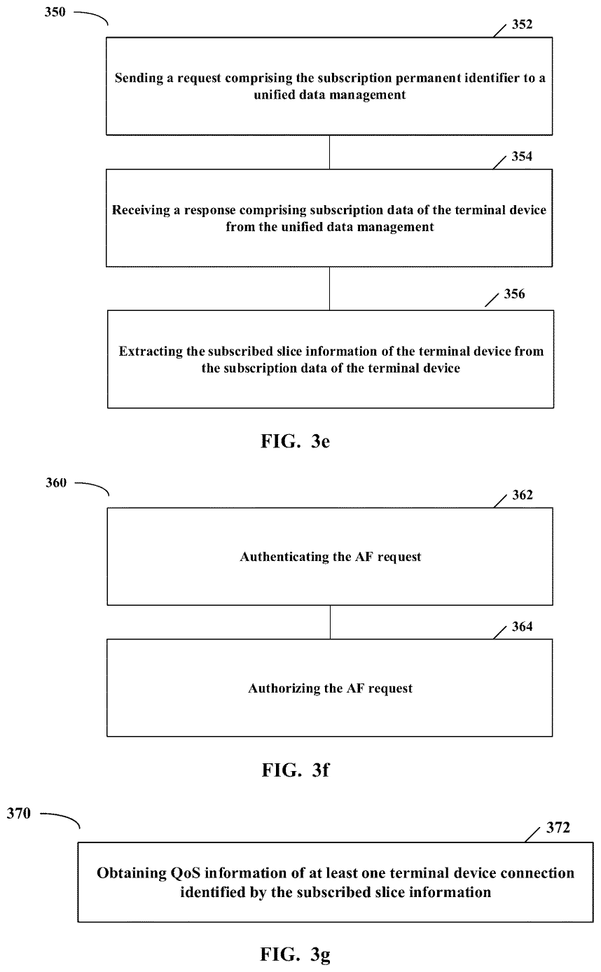

FIG. 5 shows a flowchart of a procedure of GET subscribed slices API according to an embodiment of the present disclosure.

In an embodiment, it may introduce a new ‘GET subscribed slices’ network capability and API to NEF.

At step 501. The AF may send a ‘GET subscribed slices’ request to the NEF. The request may contain the AF ID and the GPSI of the UE. The AF may be a router management function or a router. The router may equip with multiple 5G modems (UEs) with different carrier SIM cards for redundancy and/or capacity purpose.

At step 502. The NEF may perform AF authentication and/or authorization. If the authorization and/or authorization are failed, the NEF may reply to the AF with a result value indicating authorization and/or authorization failure. Otherwise the NEF proceeds with the following steps.

At step 503. The NEF may perform UDM discovery using the GPSI of the UE towards the NRF. Based on the discovery result, NEF may select a UDM instance.

At step 504. The NEF may send a ‘GET ID translation result’ request to the selected UDM. The request may contain the GPSI of the UE.

At step 505. The UDM may send a ‘GET ID translation result’ response back to the NEF. The response may contain the SUPI of the UE.

At step 506. The NEF may send a ‘GET UE's Session Management Subscription Data’ request to the selected UDM. The request may contain the SUPI of the UE.

At step 507. The UDM may send a ‘GET UE's Session Management Subscription Data’ response back to the NEF. The response may contain the SmSubsData, i.e., the session management subscription data of the targeted UE.

At step 508. The NEF may extract the S-NSSAI information and DNN configuration information from the SmSubsData.

At step 509. The NEF may send a ‘GET subscribed slices’ response back to the AF. The response may contain the S-NSSAI information and DNN configuration information. The information models of the response are as blow.

An example of the information model of S-NSSAI is illustrated as below Table 1.

TABLE 1
Snssais

| Information element | Description |
|---|---|
| sst | Slice/Service Type |
| sd | Slice Differentiator |
| dnnConfigurations | A list of DNNs applicable for the network slice |

It is noted that in other embodiments, the information model of S-NSSAI may comprise more or less information elements or other information elements.

An example of the information model of DnnConfiguration is illustrated as below Table 2.

TABLE 2
DnnConfiguration

| Information element | Description |
|---|---|
| dnn | Distributed Network Name |
| pduSessionTypes | Indicates the type of a PDU session: |
| | IPV4 |
| | IPV6 |
| | IPV4V6 |
| | UNSTRUCTURED |
| | ETHERNET |
| sscModes | Represents the service and session continuity mode: |
| | SSC_MODE_1 |
| | SSC_MODE_2 |
| | SSC_MODE_3 |
| 5gQosProfile | The subscribed default QoS, including 5QI and the ARP, |
| | maybe the priority level. |

It is noted that in other embodiments, the information model of DnnConfiguration may comprise more or less information elements or other information elements.

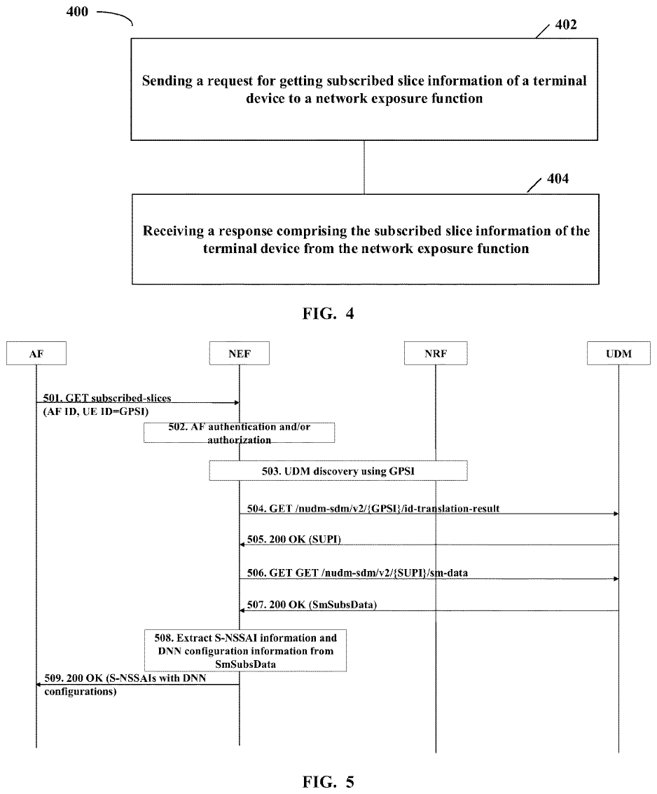

FIG. 6a shows a flowchart of a procedure of router management according to an embodiment of the present disclosure.

At step 601. The administrator may create routing policies for the router(s) inside the router management function. A routing policy may include application descriptor and QoS requirements.

At step 602. The router may send an ‘Application lookup’ request to the router management function. The request may include application context and GPSI of the modem (UE) inside the router.

At step 603. The router management function may looks up the routing policy based on the application context.

At step 604. The router management function may send a ‘GET subscribed slices’ request to the NEF. The request may contain the AF ID and the GPSI of the modem (UE).

At step 605. The NEF may send a ‘GET subscribed slices’ response back to the router management function. The response may contain the S-NSSAI information and DNN configuration information.

At step 606. The router management function may determine the slice based on the QoS requirements of the policy.

At step 607. The router management function may send an ‘Application lookup’ response back to the Router. The response may include Application ID and S-NSSAI of the slice.

At step 608. If no existing PDU session available for the target slice, the router may establish a PDU session for the target slice.

At step 609. The router may route corresponding application traffic using the target slice.

FIG. 6b shows a flowchart of a procedure of GET device connections API according to an embodiment of the present disclosure.

This embodiment introduces additional QoS profile information exposed to the application function. The QoS profile information may give the application function more insight on the QoS provided by the device connection (e.g., PDU session) so that the application function can implement more intelligence to steer traffic across multiple device connections.

At step 621. The OSS may provision QoS profile information to the NEF. A QoS profile may indicate the default QoS characteristics of a device connection.

At step 622. The AF may send a ‘GET device connections’ request to the NEF. The request may contain the AF ID and the UE ID where the UE ID may be either GPSI or SUPI. At step 623. The NEF may perform AF authentication and authorization.

At step 624. If the UE ID is GPSI, the NEF may perform UDM discovery using the GPSI of the UE towards the NRF. Based on the discovery result, NEF may select a UDM instance.

At step 625. The NEF may send a ‘GET ID translation result’ request to the selected UDM. The request may contain the GPSI of the UE.

At step 626. The UDM may send a ‘GET ID translation result’ response back to the NEF. The response may contain the SUPI of the UE.

At step 627. If the UE ID is SUPI, the NEF may perform UDM discovery using the SUPI of the UE towards the NRF. Based on the discovery result, NEF may select a UDM instance.

At step 628. The NEF may send a ‘GET UE's Session Management Subscription Data’ request to the selected UDM. The request may contain the SUPI of the UE.

At step 629. The UDM sends a ‘GET UE's Session Management Subscription Data’ response back to the NEF. The response may contain the SmSubsData, i.e., the session management subscription data of the targeted UE.

At step 630. The NEF may extract the S-NSSAI information and DNN configuration information from the SmSubsData and construct the device connections data. Each device connection may be uniquely identified by DNN and S-NSSAI combination.

At step 631. For each device connection, the NEF may look up QoS Profile by DNN and S-NSSAI.

At step 632. The NEF may send a ‘GET device connections’ response back to the AF. The response may contain at least one device connection information. Each device connection information may comprise at least one information element of table 3.

In an embodiment, the information model of device connection may be illustrated as below table 3.

TABLE 3
Device Connection

| Information element | description |
|---|---|
| > S-NSSAI | |
| >> sst | Slice/Service Type |
| >> sd | Slice Differentiator |
| > dnn | Distributed Network Name |
| > QoS Properties | |
| >> pduSessionTypes | Indicates the type of a PDU session: |
| | IPV4 |
| | IPV6 |
| | IPV4V6 |
| | UNSTRUCTURED |
| | ETHERNET |
| >> sscModes | Represents the service and session continuity mode: |
| | SSC_MODE_1 |
| | SSC_MODE_2 |
| | SSC_MODE_3 |
| >> 5QI | |
| > QoS Profile | The QoS Profile includes the QoS characteristics |
| | information for a device connection. |
| >> targetMinUpstreamRate | Minimum upstream rate ensured by GBR QCI. |
| >> maxUpstreamRate | The maximum upstream best effort data rate. |
| >> maxUpstreamBurstRate | Enable the network to burst data at a higher rate than the |
| | maxUpstreamRate for a period of time. |
| >> targetMinDownstreamRate | Minimum downstream rate ensured by GBR QCI. |
| >> maxDownstreamRate | The maximum downstream best effort data rate. |
| >>maxDownstreamBurstRate | Enable the network to burst data at a higher rate than the |
| | maxDownstreamRate for a period of time. |
| >> priority | Priority levels allow efficient resource allocation and |
| | ensure optimal performance for various services. |
| >> packetDelayBudget | The packet delay budget is the maximum allowable |
| | one-way latency between the terminal device and the |
| | gateway from the operator's network to other networks. |
| >> jitter | The jitter requirement aims to limit the maximum |
| | variation in round-trip packet delay for the 99th |
| | percentile of traffic, following ITU Y.1540 standards. |
| >> packetErrorLossRate | The exponential power of the allowable error loss |
| | rate 10^{(-N)}. |

FIG. 6c shows a flowchart of a procedure of router management according to another embodiment of the present disclosure.

At step 651. The administrator may create routing policies for the router(s) inside the router management function. A routing policy may include application descriptor and QoS requirements.

At step 652. The router may send an ‘Application lookup’ request to the router management function. The request may include application context and GPSI of the modem (UE) inside the router.

At step 653. The router management function may looks up the routing policy based on the application context.

At step 654. The router management function may send a ‘GET device connections’ request to the NEF. The request may contain the AF ID and the GPSI of the modem (UE).

At step 655. The NEF may send a ‘GET device connections’ response back to the router management function. The response may contain at least one device connection information.

At step 656. The router management function may determine the device connection based on the QoS requirements of the policy.

At step 657. The router management function may send an ‘Application lookup’ response back to the Router. The response may include the application ID and information regarding the determined device connection (such as DNN and S-NSSAI, or S-NSSAI).

At step 658. If no existing PDU session available for the determined device connection, the router may establish a PDU session for the determined device connection.

At step 659. The router may route corresponding application traffic using the determined device connection.

Some messages of FIGS. 5, 6a, 6b, and 6c may be same as the corresponding messages as described in various 3GPP specifications such as 3GPP TS 23.502 V18.0.0. Some messages of FIGS. 5, 6a, 6b, and 6c are new according to some embodiments of the present disclosure.

Many advantages may be achieved by applying the proposed solution according to embodiments of the present disclosure. In some embodiments herein, it can enable the AF (such as a router management function or a router) to retrieve subscribed slice information of a given terminal device. In some embodiments herein, it can enable the AF (such as a router management function or a router) to retrieve QoS information of at least one terminal device connection of a given terminal device. In some embodiments herein, the AF can automate/improve the procedure(s) which requires slice information or QoS information of a terminal device connection(s). In some embodiments herein, it can improve efficiency. The embodiments herein are not limited to the features and advantages mentioned above. A person skilled in the art will recognize additional features and advantages upon reading the following detailed description.

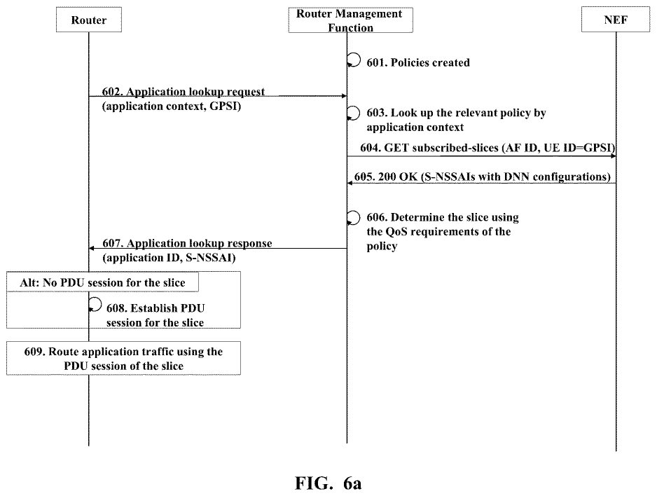

FIG. 7 is a block diagram showing an apparatus suitable for practicing some embodiments of the disclosure. For example, the network exposure function or the application function described above may be implemented as or through the apparatus 700.

The apparatus 700 may comprise at least one processor 721, such as a digital processor (DP), and at least one memory (MEM) 722 coupled to the processor 721. The apparatus 700 may further comprise a transmitter TX and receiver RX 723 coupled to the processor 721. The MEM 722 stores a program (PROG) 724. The PROG 724 may include instructions that, when executed on the associated processor 721, enable the apparatus 700 to operate in accordance with the embodiments of the present disclosure. A combination of the at least one processor 721 and the at least one MEM 722 may form processing means 725 adapted to implement various embodiments of the present disclosure.

Various embodiments of the present disclosure may be implemented by computer program executable by one or more of the processor 721, software, firmware, hardware or in a combination thereof.

The MEM 722 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 721 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the network exposure function, the memory 722 contains instructions executable by the processor 721, whereby the network exposure function operates according to any of the methods performed by the network exposure function as described above.

In an embodiment where the apparatus is implemented as or at the application function, the memory 722 contains instructions executable by the processor 721, whereby the application function operates according to any of the methods performed by the application function as described above.

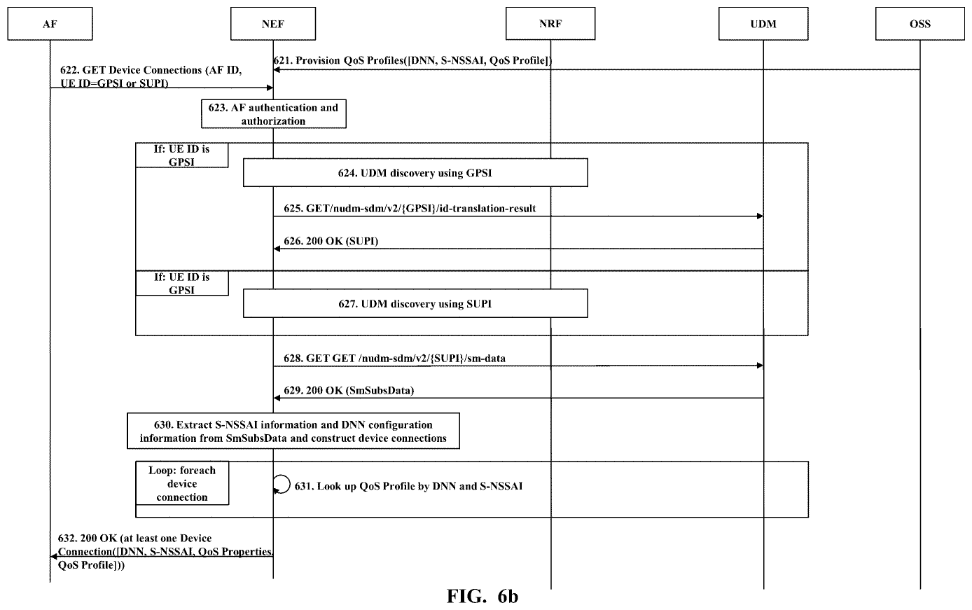

FIG. 8a is a block diagram showing a network exposure function according to an embodiment of the disclosure. As shown, the network exposure function 800 may comprise a first receiving module 801 configured to receive a first request for getting subscribed slice information of a terminal device from an application function. The network exposure function 800 may comprise a first sending module 802 configured to send a first response comprising the subscribed slice information of the terminal device to the application function.

In an embodiment, the network exposure function 800 may further comprise an obtaining module 803 configured to obtain a subscription permanent identifier based on the terminal device identifier or the terminal device address information.

In an embodiment, the network exposure function 800 may further comprise a second sending module 804 configured to send a request comprising the subscription permanent identifier to a unified data management.

In an embodiment, the network exposure function 800 may further comprise a second receiving module 805 configured to receive a response comprising subscription data of the terminal device from the unified data management.

In an embodiment, the network exposure function 800 may further comprise an extracting module 806 configured to extract the subscribed slice information of the terminal device from the subscription data of the terminal device.

In an embodiment, the network exposure function 800 may further comprise an authenticating module 807 configured to authenticate the first request.

In an embodiment, the network exposure function 800 may further comprise an authorizing module 808 configured to authorize the first request.

In an embodiment, the network exposure function 800 may further comprise an obtaining module 809 configured to obtain QoS information of at least one terminal device connection identified by the subscribed slice information.

FIG. 8b is a block diagram showing an application function according to an embodiment of the disclosure. As shown, the application function 860 may comprise a sending module 861 configured to send a first request for getting subscribed slice information of a terminal device to a network exposure function. The application function 860 may further comprise a receiving module 862 configured to receive a first response comprising the subscribed slice information of the terminal device from the network exposure function.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the network exposure function or the application function may not need a fixed processor or memory, any computing resource and storage resource may be arranged from the network exposure function or the application function in the communication system. The introduction of virtualization technology and network computing technology may improve the usage efficiency of the network resources and the flexibility of the network.

Further, the exemplary overall commutation system including the terminal device and the network node will be introduced as below.

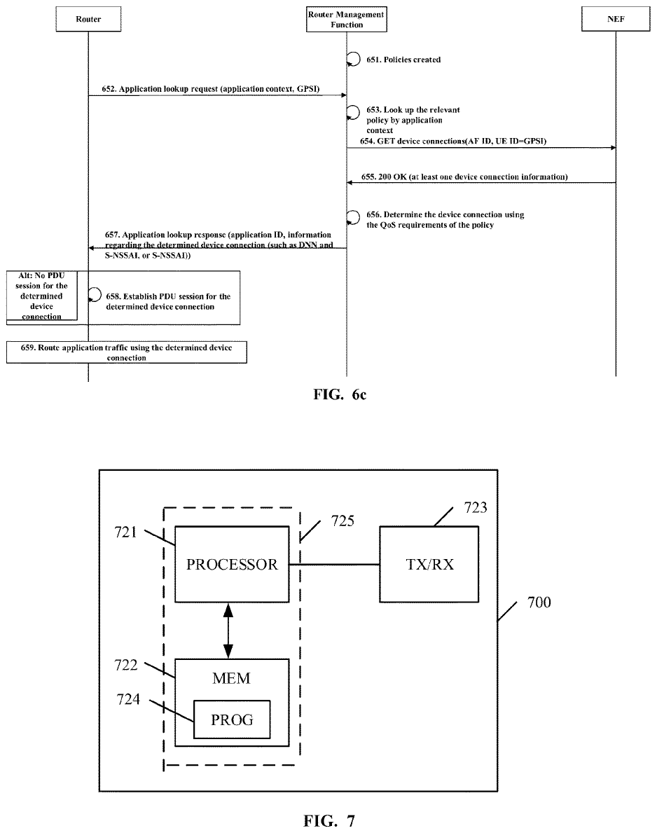

FIG. 9 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network QQ102 includes one or more Open-RAN (ORAN) network nodes. An ORAN network node is a node in the telecommunication network QQ102 that supports an ORAN specification (e.g., a specification published by the O-RAN Alliance, or any similar organization) and may operate alone or together with other nodes to implement one or more functionalities of any node in the telecommunication network QQ102, including one or more network nodes QQ110 and/or core network nodes QQ108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

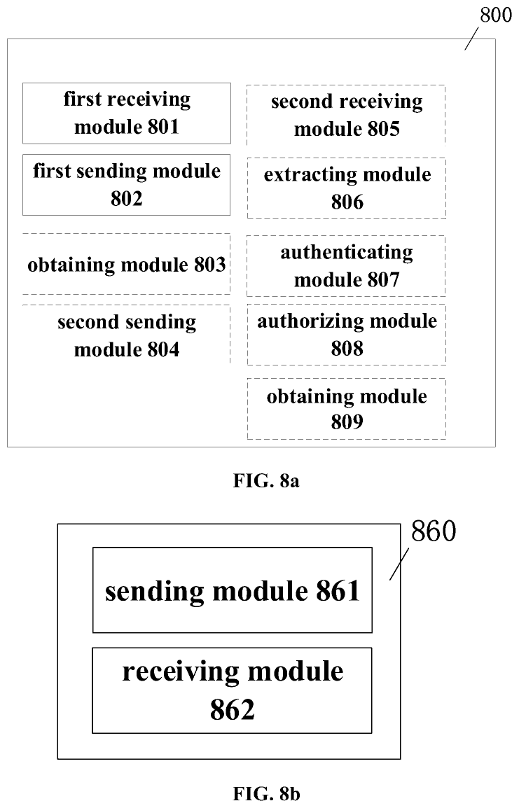

FIG. 10 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

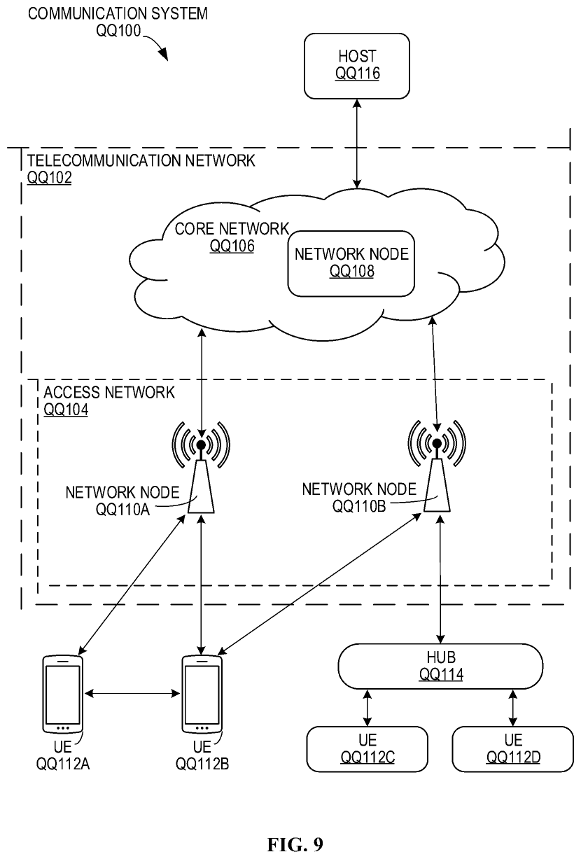

FIG. 11 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 11 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

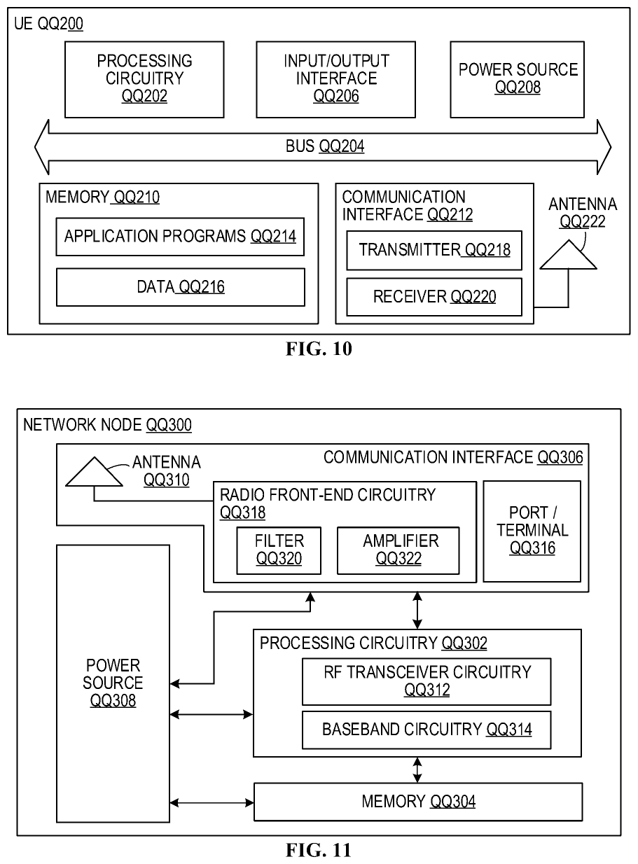

FIG. 12 is a block diagram of a host QQ400, which may be an embodiment of the host QQ116 of FIG. 9, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the terminal devices, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

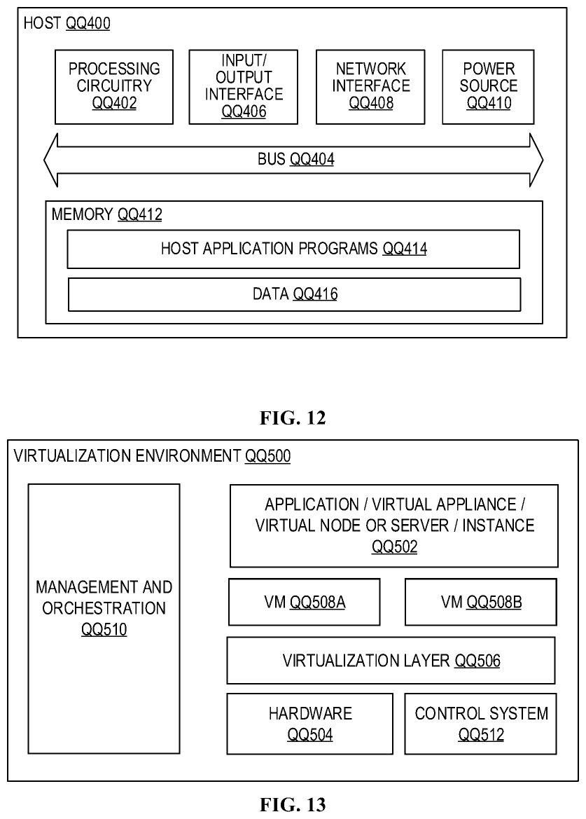

FIG. 13 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment QQ500 includes components defined by the O-RAN Alliance, such as an O-Cloud environment orchestrated by a Service Management and Orchestration Framework via an O-2 interface.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508A and QQ508B (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

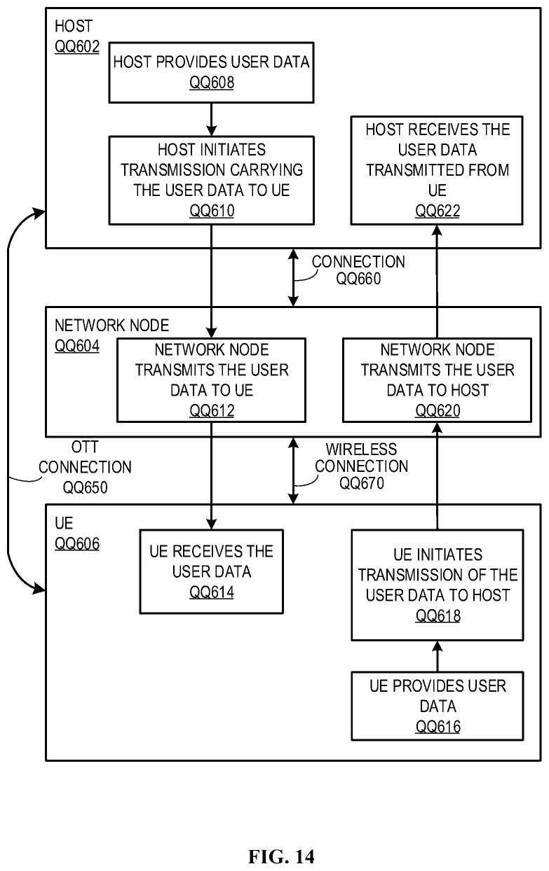

FIG. 14 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 9), network node (such as network node QQ110a of FIG. 9), and host (such as host QQ116 of FIG. 9 and/or host QQ400 of FIG. 12) discussed in the preceding paragraphs will now be described with reference to FIG. 14.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 9) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, in some embodiments herein, it can enable the AF (such as a router management function or a router) to retrieve subscribed slice information of a given terminal device. In some embodiments herein, it can enable the AF (such as a router management function or a router) to retrieve QoS information of at least one terminal device connection of a given terminal device. In some embodiments herein, the AF can automate/improve the procedure(s) which requires slice information or QoS information of a terminal device connection(s). In some embodiments herein, it can improve efficiency.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Embodiment 1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations performed by the network node as described above to transmit the user data from the host to the UE.

Embodiment 2. The host of the previous embodiment, wherein:
the processing circuitry of the host is configured to execute a host application that provides the user data; and
the UE comprises processing circuitry configured to execute a client application associated with the host application to receive the transmission of user data from the host.

Embodiment 3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs the operations performed by the network node as described above to transmit the user data from the host to the UE.

Embodiment 4. The method of the previous embodiment, further comprising, at the network node, transmitting the user data provided by the host for the UE.

Embodiment 5. The method of any of the previous 2 embodiments, wherein the user data is provided at the host by executing a host application that interacts with a client application executing on the UE, the client application being associated with the host application.

Embodiment 6. A communication system configured to provide an over-the-top (OTT) service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations performed by the network node as described above to transmit the user data from the host to the UE.

Embodiment 7. The communication system of the previous embodiment, further comprising:
the network node; and/or
the user equipment.

Embodiment 8. The communication system of the previous 2 embodiments, wherein:
the processing circuitry of the host is configured to execute a host application, thereby providing the user data; and
the host application is configured to interact with a client application executing on the UE, the client application being associated with the host application.

Embodiment 9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations performed by the network node as described above to receive the user data from the UE for the host.

Embodiment 10. The host of the previous 2 embodiments, wherein:
the processing circuitry of the host is configured to execute a host application, thereby providing the user data; and
the host application is configured to interact with a client application executing on the UE, the client application being associated with the host application.

Embodiment 11. The host of they of the previous 2 embodiments, wherein the initiating receipt of the user data comprises requesting the user data.

Embodiment 12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the operations performed by the network node as described above to receive the user data from the UE for the host.

Embodiment 13. The method of the previous embodiment, further comprising at the network node, transmitting the received user data to the host.

Embodiment 14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform any of the operations performed by the UE as described above to receive the user data from the host.

Embodiment 15. The host of the previous embodiment, wherein the cellular network further includes a network node configured to communicate with the UE to transmit the user data to the UE from the host.

Embodiment 16. The host of the previous 2 embodiments, wherein:
the processing circuitry of the host is configured to execute a host application, thereby providing the user data; and
the host application is configured to interact with a client application executing on the UE, the client application being associated with the host application.

Embodiment 17. A method implemented by a host operating in a communication system that further includes a network node and a user equipment (UE), the method comprising: providing user data for the UE; and
initiating a transmission carrying the user data to the UE via a cellular network comprising the network node, wherein the UE performs any of the operations performed by the UE as described above to receive the user data from the host.

Embodiment 18. The method of the previous embodiment, further comprising:
at the host, executing a host application associated with a client application executing on the UE to receive the user data from the UE.

Embodiment 19. The method of the previous embodiment, further comprising:
at the host, transmitting input data to the client application executing on the UE, the input data being provided by executing the host application,
wherein the user data is provided by the client application in response to the input data from the host application.

Embodiment 20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform any of the operations performed by the UE as described above to transmit the user data to the host.

Embodiment 21. The host of the previous embodiment, wherein the cellular network further includes a network node configured to communicate with the UE to transmit the user data from the UE to the host.

Embodiment 22. The host of the previous 2 embodiments, wherein:
the processing circuitry of the host is configured to execute a host application, thereby providing the user data; and
the host application is configured to interact with a client application executing on the UE, the client application being associated with the host application.

Embodiment 23. A method implemented by a host configured to operate in a communication system that further includes a network node and a user equipment (UE), the method comprising:
at the host, receiving user data transmitted to the host via the network node by the UE, wherein the UE performs any of the operations performed by the UE as described above to transmit the user data to the host.

Embodiment 24. The method of the previous embodiment, further comprising:
at the host, executing a host application associated with a client application executing on the UE to receive the user data from the UE.

Embodiment 25. The method of the previous embodiments, further comprising:
at the host, transmitting input data to the client application executing on the UE, the input data being provided by executing the host application,
wherein the user data is provided by the client application in response to the input data from the host application.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by a network exposure function, comprising:
receiving a first request for getting subscribed slice information of a terminal device from an application function; and
sending a first response comprising the subscribed slice information of the terminal device to the application function.

2. The method according to claim 1, wherein the first request comprises at least one of:
an application function identifier,
a terminal device identifier in the form of a generic public subscription identifier, or
terminal device address information.

3. (canceled)

4. The method according to claim 2, further comprising:
obtaining a subscription permanent identifier based on the terminal device identifier or the terminal device address information.

5. The method according to claim 4, wherein obtaining the subscription permanent identifier based on the terminal device identifier comprises:
sending a unified data management discovery request comprising the terminal device identifier to a network repository function;
receiving a unified data management discovery response comprising a unified data management discovery result from the network repository function;
selecting a unified data management instance based on the unified data management discovery result;
sending an identifier translation request comprising the terminal device identifier to the selected unified data management instance; and
receiving an identifier translation response comprising the subscription permanent identifier from the selected unified data management instance.

6. The method according to claim 4, wherein obtaining the subscription permanent identifier based on the terminal device address information comprises:
sending a request comprising the terminal device address information to a binding support function; and
receiving a response comprising the subscription permanent identifier from the binding support function.

7. The method according to claim 4, further comprising:
sending a request comprising the subscription permanent identifier to a unified data management;
receiving a response comprising subscription data of the terminal device from the unified data management; and
extracting the subscribed slice information of the terminal device from the subscription data of the terminal device.

8. The method according to claim 1, further comprising:
authenticating the first request; and/or
authorizing the first request.

9. The method according to claim 1, wherein the subscribed slice information of the terminal device comprises:
a list of single network slice selection assistance information (S-NSSAI), information, and
a list of data network name (DNN) configuration information for each S-NSSAI in the list of S-NSSAI.

10. (canceled)

11. The method according to claim 9, wherein the DNN configuration information comprises at least one of:
a data network name,
a type of a protocol data unit session,
a service and session continuity (SSC) mode, or
a subscribed default quality of service (QoS).

12-13. (canceled)

14. The method according to claim 11, wherein the subscribed default QoS comprises at least one of:
a fifth generation (5G) QoS identifier,
an allocation and retention priority (ARP),
a priority level,
a minimum guaranteed upstream rate,
a maximum best-effort upstream rate,
a minimum guaranteed downstream rate,
a maximum best-effort downstream rate,
a maximum downstream burst rate,
a maximum upstream burst rate,
priority information,
packet delay budget information,
jitter information,
a packet loss rate, or
a packet error rate.

15. The method according to claim 1, wherein the subscribed slice information of the terminal device is used for at least one of:
identifying at least one terminal device connection;
determining a slice or a terminal device connection that satisfies a requirement of a service; or
generating a routing policy for the service.

16. The method according to claim 1, wherein the application function comprises at least one of:
a router management function,
a router, and
wherein the terminal device comprises a router.

17-18. (canceled)

19. The method according to claim 1, further comprising:
obtaining QoS information of at least one terminal device connection identified by the subscribed slice information,
wherein obtaining the QoS information comprises;
receiving the QoS information from an operational support system or a network management system.

20. (canceled)

21. The method according to claim 19, wherein the first response further comprises the QoS information corresponding to a DNN and an S-NSSAI.

22. The method according to claim 19, wherein the QoS information comprises at least one of:
a minimum guaranteed upstream rate,
a maximum best-effort upstream rate,
a minimum guaranteed downstream rate,
a maximum best-effort downstream rate,
a maximum downstream burst rate,
a maximum upstream burst rate,
priority information,
jitter information,
packet delay budget information,
a packet loss rate, or
a packet error rate.

23. The method according to claim 22, wherein the QoS information is used for at least one of:
determining a terminal device connection that satisfies a requirement of a service; or
generating a routing policy for the service.

24-39. (canceled)

40. A network exposure function, comprising:
a processor; and
a memory coupled to the processor, the memory containing instructions executable by the processor, whereby the network exposure function is operative to:
receive a first request for getting subscribed slice information of a terminal device from an application function; and
send a first response comprising the subscribed slice information of the terminal device to the application function.

41-45. (canceled)
